(19) United States
(12) Patent Application Publication
(10) Pub. No.: US 2017/0289515 A1
(43) Pub. Date: Oct. 5, 2017

(54) HIGH DYNAMIC RANGE DEPTH GENERATION FOR 3D IMAGING SYSTEMS

(71) Applicant: Intel Corporation, Santa Clara, CA (US)

(72) Inventors: ZHENGMIN LI, Hillsboro, OR (US); TAO TAO, Portland, OR (US); GURU RAJ, Portland, OR (US); RICHMOND F. HICKS, Beaverton, OR (US); VINESH SUKUMAR, Fremont, CA (US)

(73) Assignee: Intel Corporation, Santa Clara, CA (US)

(21) Appl. No.: 15/089,024

(22) Filed: Apr. 1, 2016

(51) Int. Cl. H04N 13/00; H04N 5/225; H04N 13/02

(52) U.S. Cl. CPC H04N 13/0018; H04N 13/0022; H04N 13/0239; H04N 13/0271; H04N 5/2257; H04N 13/004

(57) ABSTRACT

High dynamic range depth generation is described for 3D imaging systems. One example includes receiving a first exposure of a scene having a first exposure level, determining a first depth map for the first depth exposure, receiving a second exposure of the scene having a second exposure level, determining a second depth map for the second depth exposure, and combining the first and second depth map to generate a combined depth map of the scene.

### FIELD

The present description relates to the field of depth images using image sensors and, in particular to increasing the accuracy of depth determinations.

### BACKGROUND

Digital camera modules continue to find more different types of platforms and uses. These include a wide variety of portable and wearable devices, including smart phones and tablets. These platforms also include many fixed and mobile installations for security, surveillance, medical diagnosis and scientific study. In all of these applications and more, new capabilities are being added to digital cameras. Significant effort has been applied to depth cameras as well as to iris and face recognition. A depth camera not only detects the appearance of the objects before it but also determines the distance to one or more of those objects from the camera.

3D stereo cameras and other types of depth sensing may be combined with powerful computing units and computer vision algorithms to provide many new computer vision tasks. These may include 3D modeling, object/skeleton tracking, car navigation, virtual/augmented reality, etc. These features rely on high quality depth measurements.

There are several options for cameras to measure depth. There are passive systems that use multiple image sensors to determine the stereo offset between image sensors that are spaced apart from each other. Projectors are used in active systems to send coded light or structured light that is then analyzed by one or more image sensors. Structured light illuminates the scene with a specific pattern. The pattern is used to triangulate individually recognized projected features. Coded light projects a time varying pattern. Distortions in the pattern are used to infer depth. Other active systems use Time of Flight from a separate laser rangefinder or LIDAR as some examples. Active illumination is also used in various face, iris, and eye recognition systems.

Stereo imaging is easy to construct for consumer photography systems because it uses proven, safe, and inexpensive camera modules, but the stereo image is dependent on matching and comparing specific features in the scene. Clear sharp features are not always visible to the sensors, so active illumination is provided by a nearby LED (Light Emitting Diode) or other type of projector. In scenes with bright ambient light such as bright sunshine the active illumination may be overwhelmed by the ambient light in which case features may be washed out.

### BRIEF DESCRIPTION OF THE DRAWING FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity.

FIG. 1 is a block diagram of a process flow for generating a depth map according to an embodiment.

FIG. 2 is a graph of a part of an exposure of an image at a first set of exposure levels according to an embodiment.

FIG. 3 is a graph of a part of an exposure of an image at a second set of exposure levels according to an embodiment.

FIG. 4 is a graph of a sum of the exposures of FIGS. 2 and 3 according to an embodiment.

FIG. 5 is a block diagram of a depth capture system using multiple exposures according to an embodiment.

FIG. 6 is a process flow diagram of capturing depth using multiple exposures according to an embodiment

FIG. 7 is a block diagram of an image sensor with multiple photodetectors and depth sensing according to an embodiment.

FIG. 8 is a block diagram of a computing device incorporating depth sensing and high dynamic range according to an embodiment

### DETAILED DESCRIPTION

The quality of a depth measurement from a 3D camera system may be improved by generating a high dynamic range (HDR) depth map. Multiple depth maps with different exposure times may be used to generate more accurate depth information under different and difficult lighting conditions. For scenes with high dynamic range scenes, in other words scenes in which the brightest part is much brighter than the darkest part, multiple images can be used to accommodate the extremes of brightness beyond the range of the depth sensing system. It is possible to determine depth using an HDR color image in which the images are combined before depth is determined. The techniques described herein are faster with fewer computations. Using two sensors, such as IR sensors, the techniques are faster than with multiple images from a single sensor.

As described herein, an HDR depth map is generated to improve depth determinations in support of many different features, including 3D modeling, object/skeleton tracking, car navigation, virtual/augmented reality, etc. Multiple depth maps that are calculated from images captured with different exposure times are combined. The weighted sum of these depth maps can cover depth information under conditions of very bright, direct sunlight to conditions of extreme shade. The weighted sum may cover ranges of brightness that cannot be covered by traditional depth generation methods.

The dynamic range of a captured image is limited by the physics of the image sensor. Only a limited range of brightness levels can be captured by an image sensor. There is great design pressure for sensors to be smaller and consume less power. This further reduces the range of brightness that can be measured. These are then provided in 256 different levels for an 8 bit output, 1024 levels for 10 bits, etc. Increasing sensor exposure time can capture dark area information but doing this loses bright area information, and vice versa. A depth map generated from a low dynamic range image does not include the depth information of any areas that are too bright or too dark. A depth map generated from a low dynamic range image e.g. 8 bits may also lack sufficient resolution to support some computer vision or image analysis functions.

By combining multiple depth maps generated from images with short exposure times and long exposure times, all of the missing information from a single image may be obtained. This approach may be used to provide a depth map for the whole image and also to provide higher resolution, i.e. more bits, for most or all of the image.

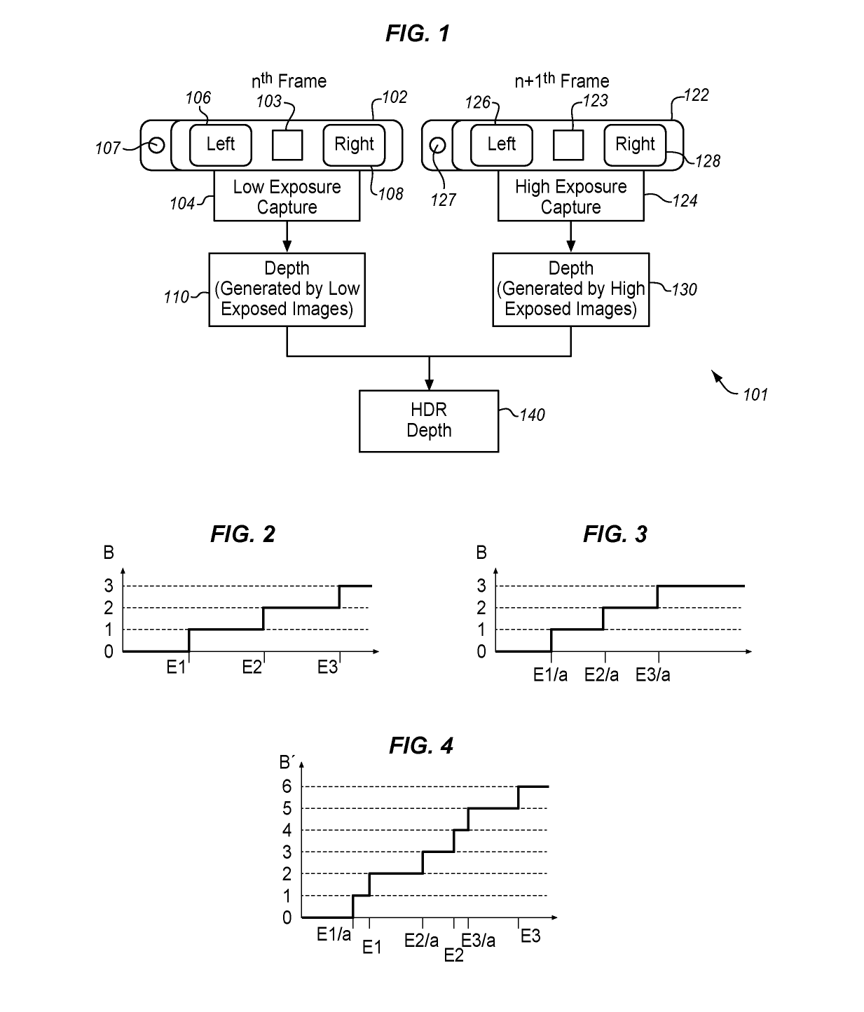

FIG. 1 is a block diagram of a process flow for generating an HDR depth map using multiple image sensors. A depth imaging system or module 101 has a depth imaging camera 102 with a left image sensor 106 and a right image sensor 108. These may be conventional RGB or RGB+IR or any other type of sensor. There may also be a projector 107 associated with the sensor to illuminate a scene. The left and right sensors capture an image of the same scene, with or without use of the projector and this is stored in a buffer 104 as a low exposure capture.

The depth imaging system may have additional image sensors or other types of depth sensors may be used instead of image sensors. The projector may be an LED (Light Emitting Diode) lamp to illuminate the RGB field for each sensor or the projector may be an IR LED or laser to illuminate the IR field for detection by a depth sensor.

At the n^{th} frame as represented by the first image sensor 102, the left 106 and the right 108 image sensors in the module 102 stream images with a low exposure value. An ASIC 103 in the image module calculates a depth map from these two images. Using the low exposure images, the depth map preserves information in bright areas while at the same time losing information in dark regions. A low exposure image in this context is one with a short exposure time, a small aperture or both. The ASIC may be part of the image module or it may be a separate or connected image signal processor or it may be a general purpose processor.

Exposure bracketing is used so that the same sensor may output frames with different exposure values. Here two frames n and n+1 are used to capture two different exposure levels but there may be more. At the n+1^{th} frame, the same imaging module 122 captures an image with a high exposure caused by a longer exposure time, larger aperture, brighter projector 127 or some combination. Left 126 and right 128 image sensors may also stream images with a high exposure value. These images are processed by the image module ASIC 123 or image signal processor to produce a second high exposure depth map which is stored in a second buffer 130. This high exposure depth map from the ASIC includes information from the dark regions while bright region are washed out.

These two depth maps from the n^{th} and n+1^{th} depth frame are combined by the ASIC or a separate processor to generate an HDR depth map which is stored in a separate buffer 140. The HDR process may alternatively be implemented in an application layer in a GPU (Graphics Processing Unit) or a CPU (Central Processing Unit).

FIGS. 2 to 4 illustrate how brightness levels and similarly the dynamic range of the depth map is increased by combining two frames with different exposure values. FIG. 2 is a graph of the brightness value B on the vertical axis against the Exposure value E on the horizontal axis. E may correspond to exposure time, projector brightness, aperture or any other exposure control. There are three exposures E1, at brightness level 1, E2 at brightness level 2 and E3 at brightness level 3. The total range of brightness is from 0 to 3. This graph suggests a sequence of three images at different exposure levels.

FIG. 3 is a similar graph of brightness versus exposure for another sequence of frames. There are three exposures E1/a, at brightness level 1, E2/a at brightness level 2 and E3/a at brightness level 3. The total range of brightness is also from 0 to 3 for this sequence of images. This graph is to suggest that for any set of images taken with the same sensor the range of brightness will be the same and is indicated here as from 0 to 3.

FIG. 4 is a similar graph of brightness B versus exposure E for the combination of the two graphs of FIGS. 1 and 2. As shown there are more brightness levels and the scale is from 0 to 6 which provides a greater dynamic range. Here the steps in brightness are from 0 to 6 for the combined exposures.

Similar results may be obtained when capturing depth with different IR projector power levels. With higher IR power, distant objects can be detected, with lower IR power, close objects can be detected. By combining two images with different power levels together, HDR depth is obtained that includes both near and far objects. The exposure values selected for each frame or exposure may be determined by minimizing the difference between the camera response curve and an emulated camera response curve.

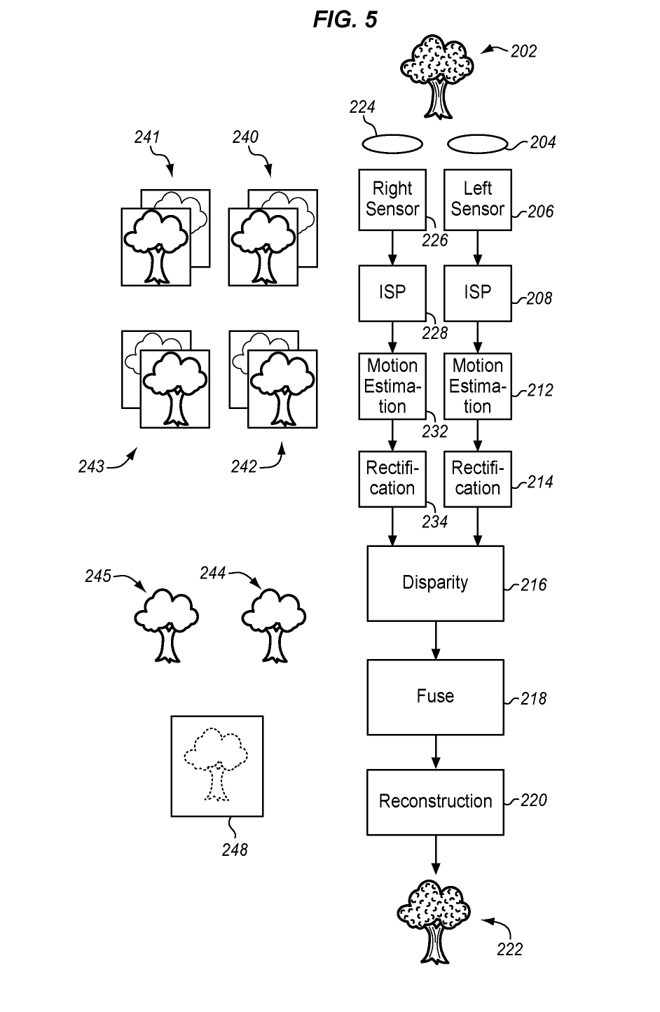

FIG. 5 is block diagram of a different depth capture system using multiple exposures. In FIG. 5 a scene 202 represented by a tree is captured by a left 226 and a right 206 image sensor. The image sensors view the scene through respective left 224 and right 204 imaging optics. These optics focus the light from the scene onto the image sensors and may include shutters or adjustable apertures to control the exposure level for each exposure.

The images are processed through separate left and right pipelines in this example. In these pipelines, the images are first received at image signal processors (ISP) for the left 229 and the right 208 image sensors, respectively. The ISPs convert the raw output of the sensors to images in an appropriate color space (e.g. RGB, YUV, etc.). The ISPs may also perform additional operations including some of the other operations described here and other operations.

In this example, there may be multiple exposures of the same scene 202 on each sensor. This is represented by two left images at 240, a long and darker exposure in the front over a shorter and lighter exposure in back. These are the raw images by the left image sensor that is then processed by the ISP. There are also two right images indicated at 241. These images are processed by the respective ISPs 208, 228 to determine an overall set of image brightness values in an image format for the left and the right, respectively.

The images 240, 241 may show motion effects because the different exposures are taken at different times. This is shown for the left as the light and dark images 242 being slightly rotated with respect to each other. Similarly, the sequence of images 243 for the right sensor may also be rotated or moved in a similar way. Respective left 232 and right 212 motion estimation blocks which may be within the ISPs or in a separate graphics or general processor estimate the motion and compensate by aligning features in the sequence of images to each other.

The left and right images may also be rectified in respective left 214 and right 234 rectification modules. The sequential images are transformed into a rectified image pair by finding a transformation or projection that maps points or objects of one image, e.g. light exposure onto the corresponding points or objects of the other image, e.g. dark exposure. This aids with combining the depth maps later. The motion compensated and rectified sequence of images is indicated as perfectly overlapping images for the left sensor 244 and for the right sensor 245. In practice, the images will be only approximately and not perfectly aligned as shown.

At 216, the disparity between the left and right images of each exposure may be determined. This allows each left and right image pair to produce a depth map. Accordingly for the two exposures, discussed herein, there will be a light exposure depth map and a dark exposure depth map. There may be more depth maps if more exposures are taken. These depth maps are fused at 218 to provide a single depth map for the scene 202. This provides the high definition depth map of 248. From the disparity, the final depth image may be reconstructed at 220 to produce a full color image with enhanced depth 250. The depth of the final image will have much of the depth detail of the original scene 202. In the final fused or combined depth map the detail captured in all of the exposures, e.g. light and dark, will be present. The color information may be generated from one or more exposures, depending on the implementation.

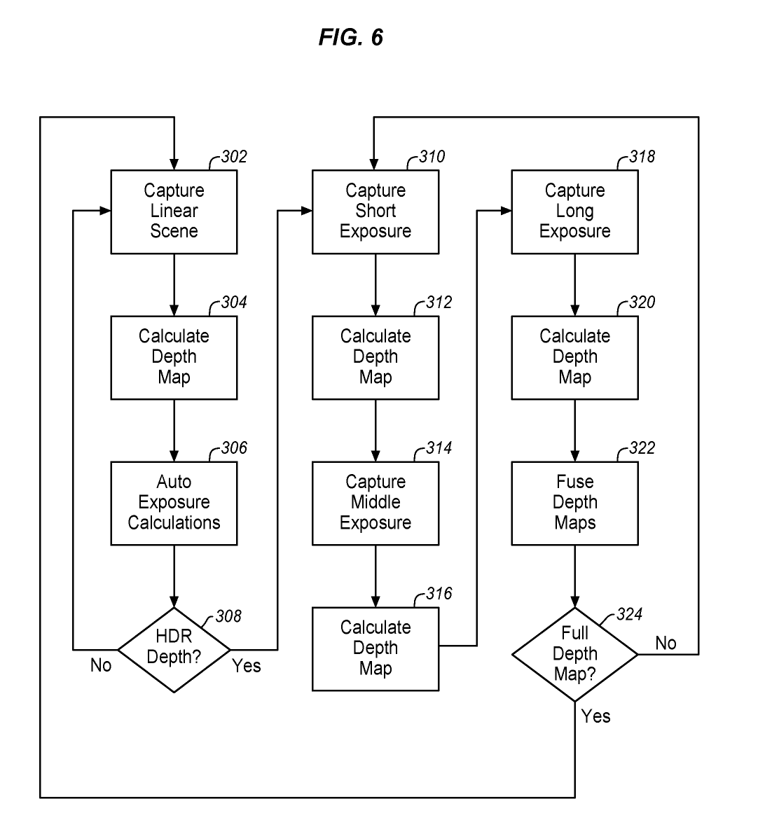

FIG. 6 is a process flow diagram of a multiple exposure depth process. This process repeats through cycles. The cycles may be considered as starting at 302 with the linear capture of a scene such as the scene 202. After the scene is captured, then a depth cloud may be calculated at 304.

At 306 as set of automatic exposure calculations are made. This allows the system to determine whether the original linear exposure was well suited to the scene. Appropriate exposure adjustments may be made for the next exposure which may replace or supplement the original exposure at 302. At 308, the exposure information may be used to determine whether to take a sequence of HDR depth exposures. As an example, if the exposure was not well suited to the scene, for example, if the image is too bright or too dark, then the scene may be appropriate for an HDR depth exposure and the process goes to 310. In another example, if the scene has high contrast so that some portions are well exposed and other portions are too bright or too dark or both, then an HDR depth exposure may be selected and the process goes to 310. On the other hand if the exposure is well suited to the scene and there is sufficient detail across the scene, then the process returns to 302 for the next linear exposure. Any automatic exposure adjustments may be made for the next linear exposure using the automatic exposure calculations.

When an HDR depth map is to be captured at 308, then the process starts to take additional exposures at 312. For multiple exposures of the scene, the system takes a short exposure at 310. As with the linear exposure, a depth map is calculated at 312. At 314, the process flow continues with additional exposures such as a middle length exposure followed by a depth map calculation at 316 and a long exposure at 318. This is also followed by a depth map calculation at 320 so that there are now three depth maps or four if the linear exposure is used. The particular order and number of the exposures may be adapted to suit different hardware implementations and different scenes. The middle or long exposure may be first and there may be more than three exposures or only two. The exposures may alternatively be simultaneous using different sensors.

At 322, the three depth maps are fused to determine a more detailed depth map for the scene using data from all three exposures. If the linear exposure has a different exposure level, then the depth map at 304 may also be fused into the complete HDR depth map. The fusion may be performed by identifying features, evaluating the quality of the depth data for each feature for each depth map and then combining the depth data from each of the depth maps so that the HDR depth map uses the best depth data from each exposure. As a result, the depth data for a feature in a dark area of the scene will be taken from the long exposure. The depth data for a feature in a brightly lit area of the scene will be taken from the short exposure. If the different exposures are based on different lamp or projector settings, then the depth data for distant features will be taken from the exposure with a bright lamp setting and the depth data for close features will be taken from the exposure with a dim lamp setting.

In some embodiments, the depth maps are combined by adding the depth at each pixel of the first depth map to the depth at each corresponding pixel of the second depth map and then normalizing the sum for each pixel. The normalizing may be done in any of a variety of ways depending on the nature of the exposures and the image capture system. In one example, the sum is normalized by dividing the sum for each pixel by the number of depth maps that are combined.

In some embodiments, a point cloud is captured when the depth map is determined. The point cloud provides a 3D set of position points to represent the external surfaces of objects in the scene and may typically have fewer points than there are pixels in the image. This point cloud represents the points that may be determined using the standard linear exposure. The point cloud may be used to determine a volumetric distance field or a depth map for the objects in the scene. Each object is represented by an object model.

The point cloud may be used to register or align object models across different exposures with ICP (Iterative Closest Point) or any other suitable technique. The ICP technique will allow the same object in two different exposures to be compared. One object may be transformed in space to best match a selected reference object. The aligned objects may then be combined to obtain a more complete point cloud of the object. ICP is an iterative technique using a cost function, however, objects may be compared and combined using any other desired approach. Once the objects are registered, then the depth maps or point clouds may be evaluated to determine how to fuse the maps together to obtain a more complete and accurate depth map or point cloud.

After the depth maps for each of the four exposures are combined, then the resulting depth map is evaluated at 324. If a full depth map has been obtained sufficient for the intended purposes, then the process returns to 302 for the next linear capture. If for any reason the depth map is not complete or full enough, then the process returns to 310 to repeat the multiple exposures. The final fused depth map suffer from a problem with the use of the camera, such as a lens being obscured, a problem with the scene such as the scene changing between exposures, a problem with the device, such as a power or processing interruption, or a problem with the selected exposure values for particularly difficult or unusual scene. In any event, the system may make another attempt at capturing an enhanced depth map starting at 310.

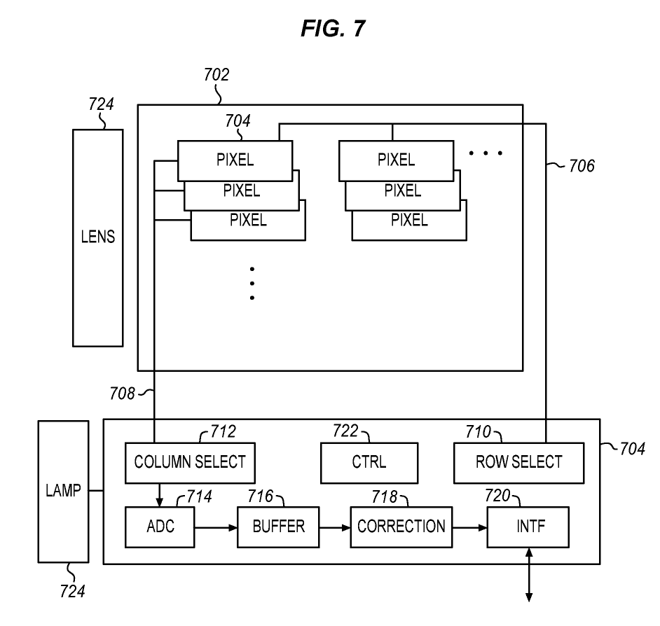

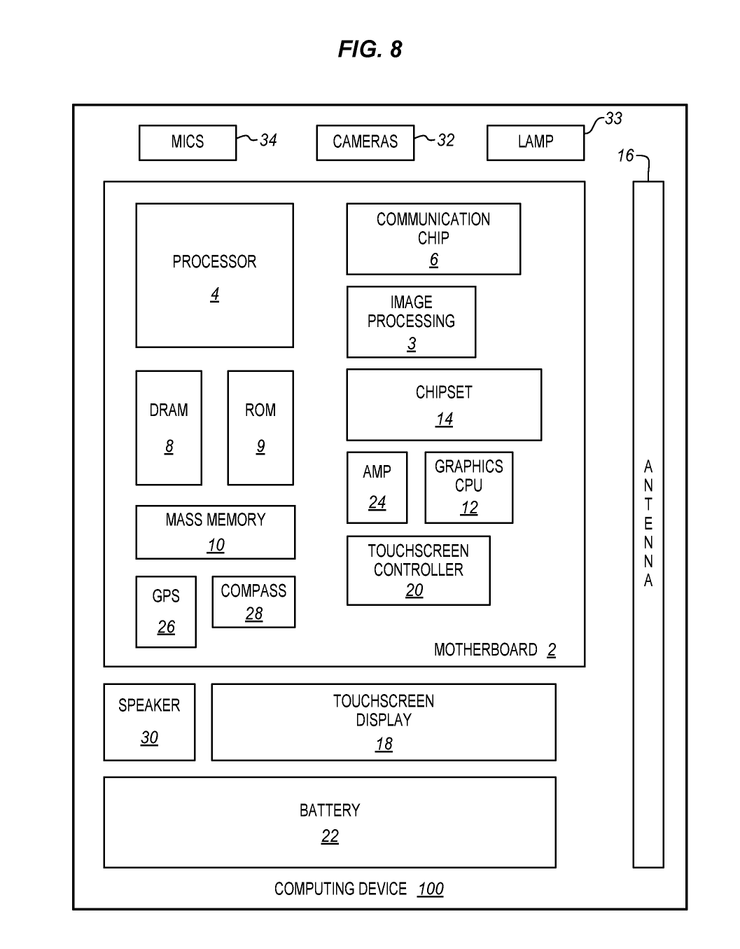

FIG. 7 is a block diagram of an image sensor or camera system 700 that may include pixel circuits with depth maps and HDR as described herein. The camera 700 includes an image sensor 702 with pixels typically arranged in rows and columns. Each pixel may have a micro-lens and detector coupled to a circuit as described above. Each pixel is coupled to a row line 706 and a column line 708. These are applied to the image processor 704.

The image processor has a row selector 710 and a column selector 712. The voltage on the column line is fed to an ADC (Analog to Digital Converter) 714 which may include sample and hold circuits and other types of buffers. Alternatively, multiple ADC's may be connected to column lines in any ratio optimizing ADC speed and die area. The ADC values are fed to a buffer 716, which holds the values for each exposure to apply to a correction processor 718. This processor may compensate for any artifacts or design constraints of the image sensor or any other aspect of the system. The complete image is then compiled and rendered and may be sent to an interface 720 for transfer to external components.

The image processor 704 may be regulated by a controller 722 and contain many other sensors and components. It may perform many more operations than those mentioned or another processor may be coupled to the camera or to multiple cameras for additional processing. The controller may also be coupled to a lens system 724. The lens system serves to focus a scene onto the sensor and the controller may adjust focus distance, focal length, aperture and any other settings of the lens system, depending on the particular implementation. For stereo depth imaging using disparity a second lens 724 and image sensor 702 may be used. This may be coupled to the same image processor 704 or to its own second image processor depending on the particular implementation.

The controller may also be coupled to a lamp or projector 724. This may be an LED in the visible or infrared range, a Xenon flash, or another illumination source, depending on the particular application for which the lamp is being used. The controller coordinates the lamp with the exposure times to achieve different exposure levels described above and for other purposes. The lamp may produce a structured, coded, or plain illumination field. There may be multiple lamps to produce different illuminations in different fields of view.

FIG. 9 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a lamp 33, a microphone array 34, and a mass storage device (such as a hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 contain image sensors with pixels or photodetectors as described herein. The image sensors may use the resources of an image processing chip 3 to read values and also to perform exposure control, depth map determination, format conversion, coding and decoding, noise reduction and 3D mapping, etc. The processor 4 is coupled to the image processing chip to drive the processes, set parameters, etc.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, a digital video recorder, wearables or drones. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes receiving a first exposure of a scene having a first exposure level, determining a first depth map for the first depth exposure, receiving a second exposure of the scene having a second exposure level, determining a second depth map for the second depth exposure, and combining the first and second depth map to generate a combined depth map of the scene.

In further embodiments the first and second exposure are captured simultaneously each using a different image sensor.

In further embodiments the first and the second exposure are captured in sequence each using a same image sensor.

In further embodiments the first and second exposures are depth exposures taken using a depth sensor.

In further embodiments combining comprises fusing the first and the second depth maps.

In further embodiments combining comprises adding the depth at each pixel of the first depth map to the depth at each corresponding pixel of the second depth map and normalizing the sum for each pixel.

In further embodiments normalizing comprises dividing each sum by the number of depth maps that are combined.

In further embodiments determining a first and second depth map comprises determining first point cloud for the first exposure and a second point cloud for the second exposure, the method further comprising registering the first and second point clouds before combining the point clouds.

In further embodiments the point clouds are registered using an iterative closest point technique.

Further embodiments include motion compensating and rectifying the first exposure with respect to the second exposure before determining a first depth map and determining a second depth map.

Further embodiments include providing the combined depth map to an application.

Some embodiments pertain to a non-transitory computer-readable medium having instructions thereon that, when operated on by the computer cause the computer to perform operations that includes receiving a first exposure of a scene having a first exposure level, determining a first depth map for the first depth exposure, receiving a second exposure of the scene having a second exposure level, determining a second depth map for the second depth exposure, and combining the first and second depth map to generate a combined depth map of the scene.

In further embodiments combining comprises adding the depth at each pixel of the first depth map to the depth at each corresponding pixel of the second depth map and normalizing the sum for each pixel by dividing each sum by the number of depth maps that are combined.

In further embodiments determining a first and second depth map comprises determining first point cloud for the first exposure and a second point cloud for the second exposure, the method further comprising registering the first and second point clouds before combining the point clouds.

In further embodiments the point clouds are registered using an iterative closest point technique.

Further embodiments include motion compensating and rectifying the first exposure with respect to the second exposure before determining a first depth map and determining a second depth map.

Some embodiments pertain to a computing system that includes a depth camera having a plurality of image sensors to capture a first and a second depth exposure of a scene, an image processor to determine a first depth map for the first depth exposure and a second depth map for the second depth exposure, and a general processor to combine the first and the second depth map to generate a combined depth map of the scene, and to provide the combined depth map to an application.

In further embodiments the first depth exposure has a different exposure level than the second depth exposure.

In further embodiments the depth camera further comprises a shutter for each of the plurality of image sensors and the first depth exposure has a different exposure level by having a different shutter speed.

In further embodiments the depth camera further comprises a lamp to illuminate the scene and wherein the first depth exposure has a different illumination level from the lamp than the second depth exposure.

What is claimed is:

1. A method comprising:
receiving a first exposure of a scene having a first exposure level;
determining a first depth map for the first depth exposure;
receiving a second exposure of the scene having a second exposure level;
determining a second depth map for the second depth exposure; and
combining the first and second depth map to generate a combined depth map of the scene.

2. The method of claim 1, wherein the first and second exposure are captured simultaneously each using a different image sensor.

3. The method of claim 1, wherein the first and the second exposure are captured in sequence each using a same image sensor.

4. The method of claim 1, wherein the first and second exposures are depth exposures taken using a depth sensor.

5. The method of claim 1, wherein combining comprises fusing the first and the second depth maps.

6. The method of claim 1, wherein combining comprises adding the depth at each pixel of the first depth map to the depth at each corresponding pixel of the second depth map and normalizing the sum for each pixel.

7. The method of claim 5, wherein normalizing comprises dividing each sum by the number of depth maps that are combined.

8. The method of claim 1, wherein determining a first and second depth map comprises determining first point cloud for the first exposure and a second point cloud for the second exposure, the method further comprising registering the first and second point clouds before combining the point clouds.

9. The method of claim 8, wherein the point clouds are registered using an iterative closest point technique.

10. The method of claim 1, further comprising motion compensating and rectifying the first exposure with respect to the second exposure before determining a first depth map and determining a second depth map.

11. The method of claim 1, further comprising providing the combined depth map to an application.

12. A non-transitory computer-readable medium having instructions thereon that, when operated on by the computer cause the computer to perform operations comprising:
receiving a first exposure of a scene having a first exposure level;
determining a first depth map for the first depth exposure;
receiving a second exposure of the scene having a second exposure level;
determining a second depth map for the second depth exposure; and
combining the first and second depth map to generate a combined depth map of the scene.

13. The method of claim 12, wherein combining comprises adding the depth at each pixel of the first depth map to the depth at each corresponding pixel of the second depth map and normalizing the sum for each pixel by dividing each sum by the number of depth maps that are combined.

14. The method of claim 12, wherein determining a first and second depth map comprises determining first point cloud for the first exposure and a second point cloud for the second exposure, the method further comprising registering the first and second point clouds before combining the point clouds.

15. The method of claim 14, wherein the point clouds are registered using an iterative closest point technique.

16. The method of claim 12, further comprising motion compensating and rectifying the first exposure with respect to the second exposure before determining a first depth map and determining a second depth map.

17. An computing system comprising:
a depth camera having a plurality of image sensors to capture a first and a second depth exposure of a scene;
an image processor to determine a first depth map for the first depth exposure and a second depth map for the second depth exposure; and
a general processor to combine the first and the second depth map to generate a combined depth map of the scene, and to provide the combined depth map to an application.

18. The apparatus of claim 17, wherein the first depth exposure has a different exposure level than the second depth exposure.

19. The apparatus of claim 18, wherein the depth camera further comprises a shutter for each of the plurality of image sensors and wherein the first depth exposure has a different exposure level by having a different shutter speed.

20. The apparatus of claim 17, wherein the depth camera further comprises a lamp to illuminate the scene and wherein the first depth exposure has a different illumination level from the lamp than the second depth exposure.
